(19) United States
(12) Patent Application Publication
(10) Pub. No.: US 2012/0287827 A1
(43) Pub. Date: Nov. 15, 2012

(54) PRIVATE CHANNELS IN UNIFIED TELEPHONY APPLICATIONS

(75) Inventors: Arno Denne, Coolock (IE); Chelsea Christine Beerse, Fairport, NY (US); Patrick Joseph O'Sullivan, Ballsbridge (IE); Jeffrey B. Sloyer, Fishersville, VA (US)

(73) Assignee: International Business Machines Corporation, Armonk, NY (US)

(21) Appl. No.: 13/104,602

(22) Filed: May 10, 2011

(51) Int. Cl. H04L 12/16

(52) U.S. Cl. 370/261

(57) ABSTRACT

A method, computer program product, and system for private channels in unified telephony applications is described. A method may comprise allowing a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting. The method may further comprise establishing the private audio channel between the unified telephony meeting moderator and a first unified telephony meeting participant based upon, at least in part, the one or more private audio channel preferences for establishing the private audio channel. The method may additionally comprise providing the communication over the private audio channel during the unified telephony meeting.

### BACKGROUND OF THE INVENTION

Meetings may be conducted using unified telephony applications. Unified telephony meetings may include a moderator and one or more participants. Moderators may present and/or discuss slides, documents, or other content during a unified telephony meeting. Communications from the moderator, e.g., audio, may be handled by a unified telephony application and may be received by all of the one or more participants of the unified telephony meeting.

### BRIEF SUMMARY OF THE INVENTION

In a first embodiment, a method may include allowing, via one or more computing devices, a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting. The method may further include establishing, via the one or more computing devices, the private audio channel between the unified telephony meeting moderator and a first unified telephony meeting participant based upon, at least in part, the one or more private audio channel preferences for establishing the private audio channel. The method may also include providing, via the or more computing devices, the communication over the private audio channel during the unified telephony meeting, based upon, at least in part, the one or more private audio channel preferences for providing the communication over the private audio channel during the unified telephony meeting.

One or more of the following features may be included. The method may include queuing at least one of the communication over the private audio channel and the communication over the main audio channel during the unified telephony meeting based upon, at least in part, the one or more private audio channel preferences for providing the communication over the private audio channel during the unified telephony meeting. The method may additionally include routing the communication over the private audio channel during the unified telephony meeting to a first audio output associated with the unified telephony meeting moderator based upon, at least in part, the one or more private audio channel preferences for providing the communication over the private audio channel during the unified telephony meeting. Moreover, the method may include routing the communication over the main audio channel during the unified telephony meeting to a second audio output associated with the unified telephony meeting moderator based upon, at least in part, the one or more private audio channel preferences for providing the communication over the private audio channel during the unified telephony meeting.

In an implementation, the method may include adjusting a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting. The method may also include redirecting the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting. The method may further include scheduling the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting. The method may additionally include converting the communication over the private audio channel during the unified telephony meeting from speech to text based upon, at least in part, the one or more private audio channel preferences for providing the communication over the private audio channel during the unified telephony meeting. Moreover, the method may include providing the text to the unified telephony meeting moderator.

In a second embodiment, a computer program product may reside on a computer readable storage medium and may have a plurality of instructions stored on it. When executed by a processor, the instructions may cause the processor to perform operations including allowing a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting. The operations may further include establishing the private audio channel between the unified telephony meeting moderator and a first unified telephony meeting participant based upon, at least in part, the one or more private audio channel preferences for establishing the private audio channel. The operations may also include the communication over the private audio channel during the unified telephony meeting, based upon, at least in part, the one or more private audio channel preferences for providing the communication over the private audio channel during the unified telephony meeting.

One or more of the following features may be included. The operations may include queuing at least one of the communication over the private audio channel and the communication over the main audio channel during the unified telephony meeting based upon, at least in part, the one or more private audio channel preferences for providing the communication over the private audio channel during the unified telephony meeting. The operations may additionally include routing the communication over the private audio channel during the unified telephony meeting to a first audio output associated with the unified telephony meeting moderator based upon, at least in part, the one or more private audio channel preferences for providing the communication over the private audio channel during the unified telephony meeting. Moreover, the operations may include routing the communication over the main audio channel during the unified telephony meeting to a second audio output associated with the unified telephony meeting moderator based upon, at least in part, the one or more private audio channel preferences for providing the communication over the private audio channel during the unified telephony meeting.

In an implementation, the operations may include adjusting a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting. The operations may also include redirecting the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting. The operations may further include scheduling the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting. The operations may additionally include converting the communication over the private audio channel during the unified telephony meeting from speech to text based upon, at least in part, the one or more private audio channel preferences for providing the communication over the private audio channel during the unified telephony meeting. Moreover, the operations may include providing the text to the unified telephony meeting moderator.

In a third embodiment, a computing system is provided. The computing system may include at least one processor and at least one memory architecture coupled with the at least one processor. The computing system may also include a first software module executable by the at least one processor and the at least one memory architecture, wherein the first software module may be configured to a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting. Further, the computing system may include a second software module which may be configured to establish the private audio channel between the unified telephony meeting moderator and a first unified telephony meeting participant based upon, at least in part, the one or more private audio channel preferences for establishing the private audio channel. Additionally, the computing system may include a third software module which may be configured to provide the communication over the private audio channel during the unified telephony meeting, based upon, at least in part, the one or more private audio channel preferences for providing the communication over the private audio channel during the unified telephony meeting.

One or more of the following features may be included. The computing system may include a fourth software module which may be configured to queue at least one of the communication over the private audio channel and the communication over the main audio channel during the unified telephony meeting based upon, at least in part, the one or more private audio channel preferences for providing the communication over the private audio channel during the unified telephony meeting. Also, the computing system may include a fifth software module which may be configured to route the communication over the private audio channel during the unified telephony meeting to a first audio output associated with the unified telephony meeting moderator based upon, at least in part, the one or more private audio channel preferences for providing the communication over the private audio channel during the unified telephony meeting. Moreover, the computing system may include a sixth software module which may be configured to route the communication over the main audio channel during the unified telephony meeting to a second audio output associated with the unified telephony meeting moderator based upon, at least in part, the one or more private audio channel preferences for providing the communication over the private audio channel during the unified telephony meeting.

In an implementation, the computing system may include a seventh software module which may be configured to adjust a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting. The computing system may further include an eighth software module which may be configured to redirect the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting. The computing system may also include a ninth software module which may be configured to schedule the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a private channel process coupled to a distributed computing network;

FIG. 2 is a flowchart of the private channel process of FIG. 1;

FIG. 3 is a diagrammatic view of an exemplary unified telephony meeting associated with the private channel process of FIG. 1;

FIG. 4 is also a diagrammatic view of an exemplary unified telephony meeting associated with the private channel process of FIG. 1;

FIG. 5 is an exemplary graphical user interface which may be associated with the private channel process of FIG. 1; and

FIG. 6 is also an exemplary graphical user interface which may be associated with the private channel process of FIG. 1.

### DETAILED DESCRIPTION OF THE INVENTION

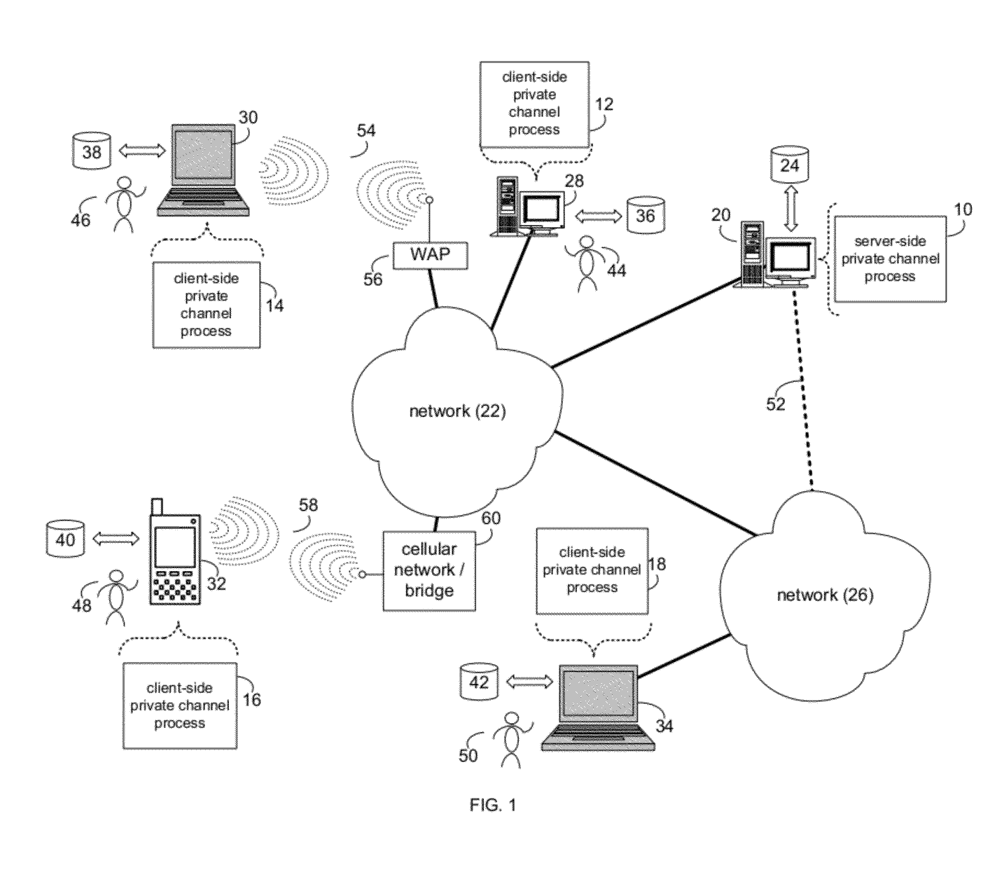

Referring to FIGS. 1 & 2, there is shown a private channel process 10. As will be discussed below, private channel process 10 may allow 100, a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting. Private channel process 10 may also establish 102 the private audio channel between the unified telephony meeting moderator and a first unified telephony meeting participant based upon, at least in part, the one or more private audio channel preferences for establishing the private audio channel. Private channel process 10 may further provide 104 the communication over the private audio channel during the unified telephony meeting, based upon, at least in part, the one or more private audio channel preferences for providing the communication over the private audio channel during the unified telephony meeting.

The private channel (PC) process may be a server-side process (e.g., server-side PC process 10), a client-side process (e.g., client-side PC process 12, client-side PC process 14, client-side PC process 16, or client-side PC process 18), or a hybrid server-side/client-side process (e.g., the combination of server-side PC process 10 and one or more of client-side PC processes 12, 14, 16, 18).

Server-side PC process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft Windows Server; Novell Netware; or Red Hat Linux, for example.

The instruction sets and subroutines of server-side PC process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS, Novell Web Server, or Apache Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side PC processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft Windows, Microsoft Windows CE, Red Hat Linux, or a custom operating system.

The instruction sets and subroutines of client-side PC processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side PC processes 12, 14, 16, 18 and/or server-side PC process 10 may be processes that run within (i.e., are part of) a unified communications and collaboration application configured for unified telephony (e.g., Lotus® Sametime®). Alternatively, client-side PC processes 12, 14, 16, 18 and/or server-side PC process 10 may be stand-alone applications that work in conjunction with the unified communications and collaboration application application. One or more of client-side PC processes 12, 14, 16, 18 and server-side PC process 10 may interface with each other (via network 22 and/or network 26). The unified communications and collaboration application may be a unified telephony application. PC process 10 may also run within any e-meeting application, web-conferencing application, or teleconferencing application configured for handling IP telephony.

Users 44, 46, 48, 50 may access server-side PC process 10 directly through the device on which the client-side PC process (e.g., client-side PC processes 12, 14, 16, 18) is executed, namely client electronic devices 28, 30, 32, 34, for example. Users 44, 46, 48, 50 may access server-side PC process 10 directly through network 22 and/or through secondary network 26. Further, server computer 20 (i.e., the computer that executes server-side PC process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Private Channel (PC) Process

For the following discussion, server-side PC process 10 will be described for illustrative purposes. It should be noted that client-side PC process 12 may interact with server-side PC process 10 and may be executed within one or more applications that allow for communication with client-side PC process 12. However, this is not intended to be a limitation of this disclosure, as other configurations are possible (e.g., stand-alone, client-side PC processes and/or stand-alone server-side PC processes.) For example, some implementations may include one or more of client-side PC processes 12, 14, 16, 18 in place of or in addition to server-side PC process 10.

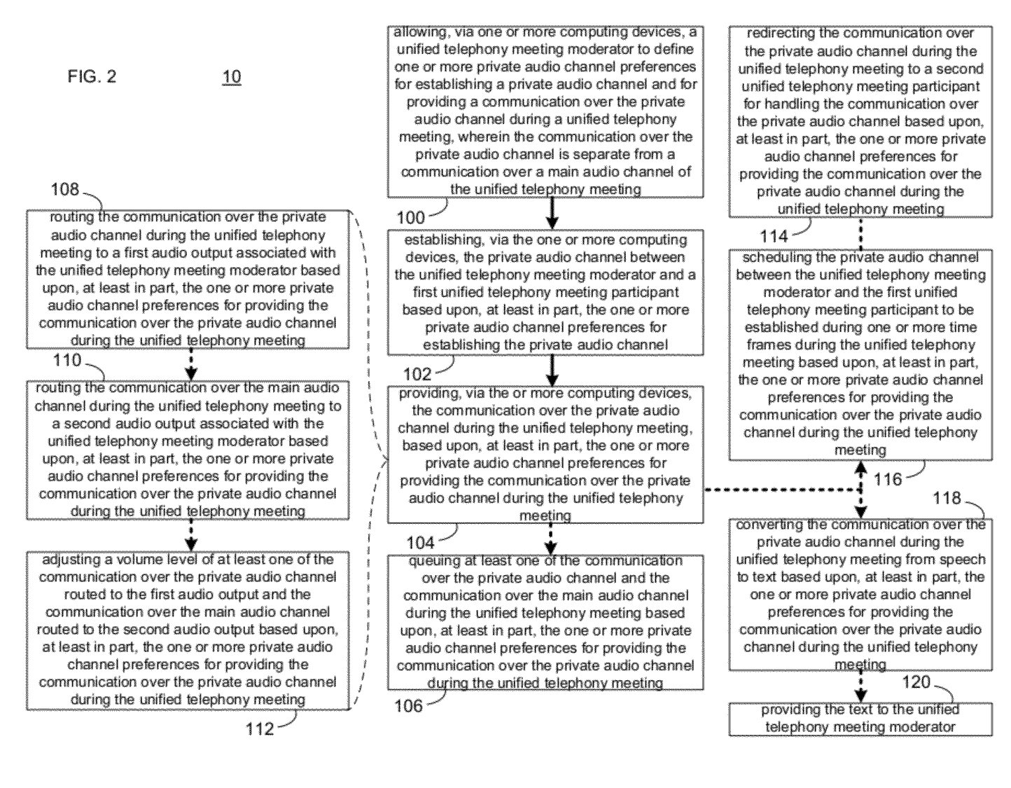

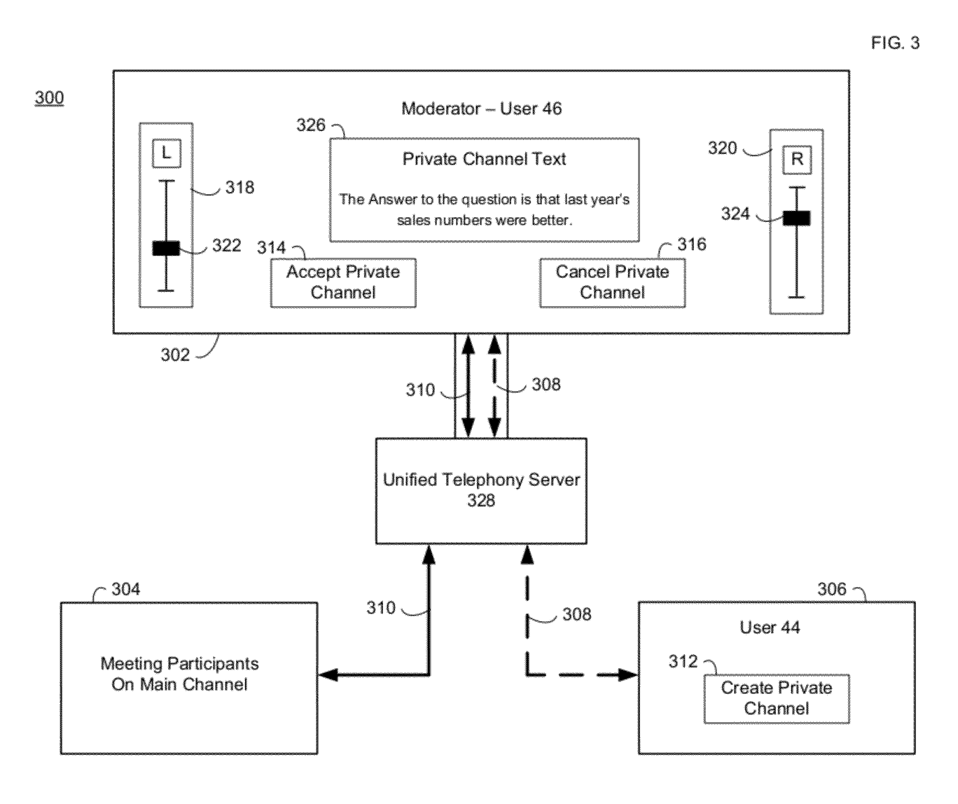

Referring now to FIGS. 1-3, one or more of users 44, 46, 48, and 50 may be unified telephony meeting participants and may be invited to a unified telephony meeting (e.g., unified telephony meeting 300). Unified telephony meeting 300 may be conducted via a unified communications and collaboration application which may be configured for unified telephony and may be a unified telephony application (e.g., Lotus® Sametime®). Unified telephony meeting 300 may be a meeting, presentation, or other type of collaborative gathering. Further, unified telephony meeting 300 may be attended online, and audio associated with unified telephony meeting 300 may be broadcasted to the one or more unified telephony meeting participants (e.g., one or more of users 44, 46, 48, 50). In an implementation, audio associated with unified telephony meeting 300 may be streamed to many unified telephony meeting participants (e.g., one or more of users 44, 46, 48, 50) or may be accessed via a voice-over-internet-protocol (VOIP) application. Unified telephony meeting 300 may have a unified telephony meeting moderator (e.g., user 46).

In some situations the unified telephony meeting moderator (e.g., user 46) and/or one or more unified telephony meeting participants (e.g., user 44) may wish to establish a private audio channel in order to communicate, without the rest of the unified telephony meeting participants (e.g., user 50) listening in. For example, user 44 may be user 46's manager and may wish to inform user 46 that user 46 is running off-schedule in user 46's presentation during a unified telephony meeting (e.g., unified telephony meeting 300). In another example, one or more other participants of the unified telephony meeting (e.g., unified telephony meeting 300) may ask user 46 a question over a main audio channel of the unified telephony meeting (e.g., unified telephony meeting 300) and user 46 may not know the answer. User 44 may wish to provide the answer to user 46 over the private audio channel such that the rest of the unified telephony meeting participants (e.g., user 50) are unable to hear that user 44 provided the answer to user 46. In these situations and others, user 46 and user 44 may benefit from a private audio channel.

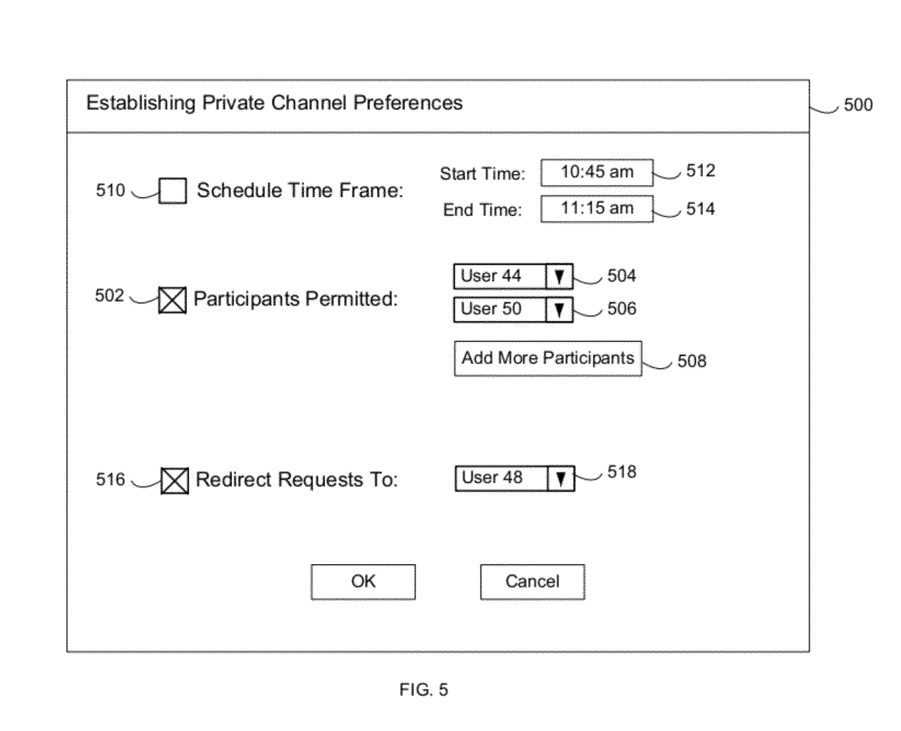

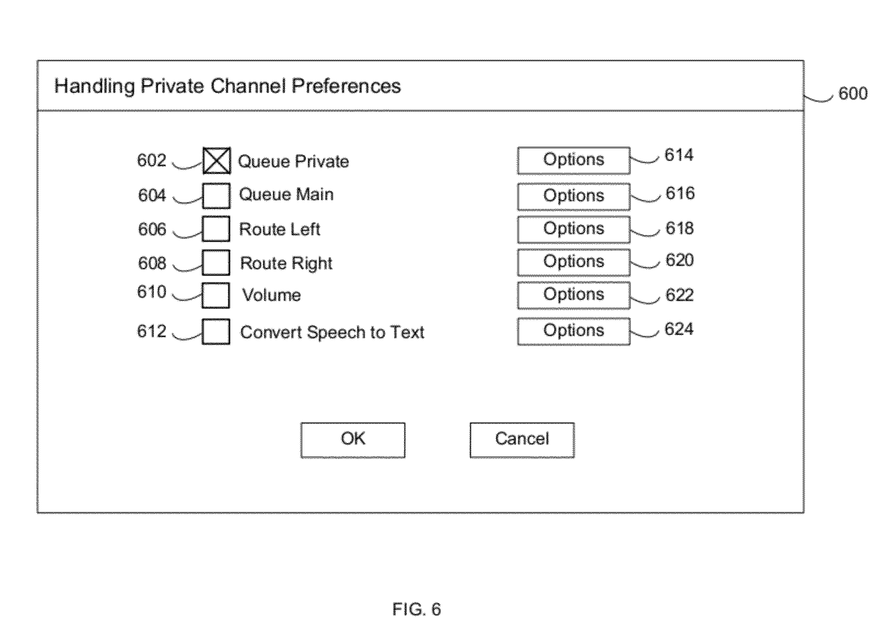

Referring now to FIGS. 1-6, PC process 10 may allow 100 a unified telephony meeting moderator (e.g., user 46) to define one or more private audio channel preferences (e.g., as shown in FIGS. 5-6) for establishing a private audio channel (e.g., channel 308) and for providing a communication over the private audio channel (e.g., channel 308) during a unified telephony meeting (e.g., unified telephony meeting 300), wherein the communication over the private audio channel (e.g., channel 308) is separate from a communication over a main audio channel (e.g., channel 310) of the unified telephony meeting. The one or more private channel preferences for establishing the private audio channel (e.g., channel 308) may be defined via graphical user interface (GUI) 500, as shown for, example, in FIG. 5. GUI 500 may be made available to user 46 via the unified communications and collaboration application. Further, the one or more private channel preferences for providing the communication over the private audio channel (e.g., channel 308) may be defined via GUI 600, as shown, for example, in FIG. 6. GUI 600 may also be made available to user 46 via the unified communications and collaboration application.

Further, PC process 10 may establish 102 the private audio channel (e.g., channel 308) between the unified telephony meeting moderator (e.g., user 46) and a first unified telephony meeting participant (e.g., user 44) based upon, at least in part, the one or more private audio channel preferences for establishing the private audio channel (e.g., channel 308). Referring now to FIG. 5, user 46 may select checkbox 502 which may define a preference indicating that certain unified telephony meeting participants may be permitted to establish 102 the private audio channel (e.g., channel 308) with the unified telephony meeting moderator (e.g., user 46). User 46 may further select “user 44” from dropdown menu 504, which may define a preference indicating that user 44 in particular may be permitted to establish 102 the private audio channel (e.g., channel 308) with the unified telephony meeting moderator (e.g., user 46). In this way, user 46 may manage which of the one or more unified telephony meeting participants are permitted to establish a private audio channel with user 46.

User 44 may request to establish 102 the private audio channel (e.g., channel 308) with the unified telephony meeting moderator (e.g., user 46) via a GUI (e.g., GUI 312) which may be available to user 46 via the unified communications and collaboration application. User 44's system (e.g., one or more of client electronic devices 28, 30, 32, 34) may send a request (not shown) to unified telephony server 328 (e.g., server computer 20) to establish the private channel. Unified telephony server 328 may handle all communications associated with unified telephony meeting 300. As user 46 defined a preference that user 44 may be permitted to establish 102 the private audio channel (e.g., channel 308) with the unified telephony meeting moderator (e.g., user 46), PC process 10 may establish 102 the private audio channel (e.g., channel 308) between user 44 and user 46 in response to user 44's request. In an implementation, PC process 10 may allow user 46 to accept or cancel the request to establish a private audio channel (e.g., via GUI 314 and/or 316). Further, in an implementation, there may be no preference to permit particular unified telephony meeting participants to establish the private audio channel and PC process 10 may always allow user 46 to accept or cancel a request to establish a private audio channel (e.g., via GUI 314 and/or 316).

Continuing with the example above, PC process 10 may provide 104 a communication over the private audio channel (e.g., channel 308) during the unified telephony meeting (e.g., unified telephony meeting 300), based upon, at least in part, the one or more private audio channel preferences (e.g., preferences 602-612 as shown in FIG. 6) for providing the communication over the private audio channel (e.g., channel 308) during the unified telephony meeting (e.g., unified telephony meeting 300). For example, user 44 may speak a communication through a microphone associated with system 306. Through, at least in part, the private audio channel (e.g., channel 308), user 46 may receive user 44's communication via one or more audio outputs associated with system 302 (e.g., one or more of client electronic devices 28, 30, 32, 34). This communication between user 44 and user 46 may not be received by other unified telephony meeting participants (e.g., 304) on the main audio channel (e.g., channel 310).

In some situations, communications of the unified telephony meeting (e.g., unified telephony meeting 300) may occur on the main audio channel (e.g., channel 310) and the private audio channel (e.g., channel 308) at or near the same time, and PC process 10 may need to determine how to handle these communications. PC process 10 may determine how to handle these communications based upon, at least in part, the one or more private audio channel preferences for providing the communication over the private audio channel (e.g., channel 308) defined via GUI 600, as shown, for example, in FIG. 6.

In an implementation, PC process 10 may queue 106 at least one of a communication over the private audio channel (e.g., channel 308) and a communication over the main audio channel (e.g., channel 310) during the unified telephony meeting (e.g., unified telephony meeting 300) based upon, at least in part, the one or more private audio channel preferences (e.g., preferences 602-612 as shown in FIG. 6) for providing the communication over the private audio channel (e.g., channel 308) during the unified telephony meeting (e.g., unified telephony meeting 300). For example, user 46 may select checkbox 602 which may define a preference indicating that, if communications of the unified telephony meeting (e.g., unified telephony meeting 300) occur on the main audio channel (e.g., channel 310) and the private audio channel (e.g., channel 308) at or near the same time, PC process 10 is to queue 106 the communication over the private audio channel (e.g., channel 308) until the communication over the main audio channel (e.g., channel 310) is complete. Once the communication over the main audio channel (e.g., channel 310) is complete, PC process 10 may allow the communication over the private audio channel (e.g., channel 308) to be received by user 46 though system 302. User 46 may select button 614 in order to define further options for this preference including, but not limited to, a maximum queue time and/or minimum queue time.

Similarly, user 46 may select checkbox 604 which may define a preference indicating that, if communications of the unified telephony meeting (e.g., unified telephony meeting 300) occur on the main audio channel (e.g., channel 310) and the private audio channel (e.g., channel 308) at or near the same time, PC process 10 is to queue the communication over the main audio channel (e.g., channel 310) until the communication over the private audio channel (e.g., channel 308) is complete. User 46 may select button 616 in order to define further options for this preference including, but not limited to, a maximum queue time and/or minimum queue time. Once the communication over the private audio channel (e.g., channel 308) is complete, PC process 10 may allow the communication over the main audio channel (e.g., channel 310) to be received by user 46 through system 302.

PC process 10 may provide many options and preferences to the unified telephony meeting moderator (e.g., user 46) for handling communications over the main audio channel (e.g., channel 310) and the private audio channel (e.g., channel 308). It should be noted that while certain options and preferences are discussed herein, these options and preferences are provided for exemplary purposes only and other variations are possible. For example, the unified telephony meeting moderator (e.g., user 46) may select one or more of check boxes 606 and 608 in order to route one or more communications to one or more audio outputs of system 302. Further, user 46 may select one or more of buttons 618 and 620 to define further preferences including, but not limited to, which audio channel (e.g., channel 308 or 310) is to be routed to a specific output (e.g., output 318, 320 of system 302).

For example, PC process 10 may route 108 the communication over the private audio channel (e.g., channel 308) during the unified telephony meeting (e.g., unified telephony meeting 300) to a first audio output (e.g., output 318) associated with the unified telephony meeting moderator (e.g., user 46) based upon, at least in part, the one or more private audio channel preferences (e.g., preferences 602-612 as shown in FIG. 6) for providing the communication over the private audio channel during the unified telephony meeting. Further, PC process 10 may route 110 the communication over the main audio channel (e.g., channel 310) during the unified telephony meeting (e.g., unified telephony meeting 300) to a second audio output (e.g., output 320) associated with the unified telephony meeting moderator (e.g., user 46) based upon, at least in part, the one or more private audio channel preferences (e.g., preferences 602-612 as shown in FIG. 6) for providing the communication over the private audio channel during the unified telephony meeting.

In an implementation, output 318 may correspond to a left speaker, or a left side of a headphone set, and output 320 may correspond to a right speaker, or a right side of a headphone set. Based upon, at least in part, preferences (e.g., preferences 602-612 as shown in FIG. 6) and options (e.g., set via buttons 614-624 as shown in FIG. 6) set by the unified telephony meeting moderator (e.g., user 46), PC process 10 may route communications over private audio channel 308 to the left side of the headphone set and communications over main audio channel 310 to the right side of the headphone set. Further, PC process 10 may adjust 112 a volume level (e.g., volume level 322, 324) of at least one of: the communications over the private audio channel (e.g., channel 308) routed to the first audio output (e.g., output 318) and the communication over the main audio channel (e.g., channel 310) routed to the second audio output (e.g., output 320) based upon, at least in part, the one or more private audio channel preferences (e.g., preferences 602-612 and/or options 614-624 as shown in FIG. 6) for providing the communication over the private audio channel during the unified telephony meeting. For example, the unified telephony meeting moderator (e.g., user 46) may wish to receive communications over the private audio channel (e.g., channel 308) in the left ear at a slightly lower volume than communications over the main audio channel (e.g., channel 310) in the right ear. This may allow the unified telephony meeting moderator (e.g., user 46) to pay attention to communications over both channels. In this way, PC process 10 may manage the volume of the main communication channel (e.g., channel 310) and the private communication channel (e.g., channel 308) and may increase or decrease the volume of one channel in favor of the other.

PC process 10 may provide many options and preferences to the unified telephony meeting moderator (e.g., user 46) for establishing communications over the private audio channel (e.g., channel 308). It should be noted that while certain options and preferences are discussed herein, these options and preferences are provided for exemplary purposes only and other variations are possible. For example, the unified telephony meeting moderator (e.g., user 46) may select one or more of check boxes 502, 510, and 516 in order to define one or more preferences for establishing a private audio channel.

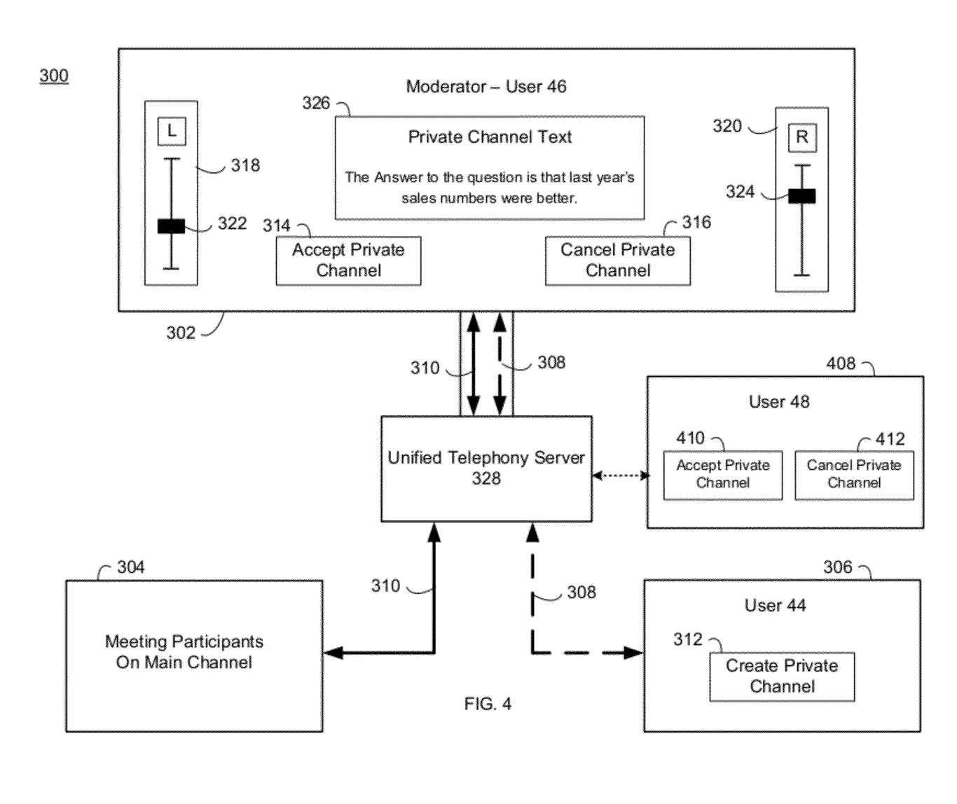

Assume for illustrative purposes that the unified telephony meeting moderator (e.g., user 46) selects checkbox 516 via GUI 500 and selects “user 48” from dropdown menu 518. This may indicate that user 46 wishes to redirect requests for establishing a private audio channel to user 48. Referring now also to FIG. 4, PC process 10 may redirect 114 a communication over the private audio channel (e.g., channel 308) during the unified telephony meeting (e.g., the unified telephony meeting 300) to a second unified telephony meeting participant (e.g., user 48) for handling the communication over the private audio channel (e.g., channel 308) based upon, at least in part, the one or more private channel preferences (e.g., one or more of check boxes 502, 510, and 516) for providing the communication over the private audio channel during the unified telephony meeting. The communication may be either a request to establish a private channel, which may include a communication in and of itself, or communication over an already established private channel.

User 48 may receive the communication via system 408 (e.g., one or more of client electronic devices 28, 30, 32, 34) and may be prompted (via, e.g., GIU 410 and/or 412, which may be available to user 46 via the unified communications and collaboration application) to accept a private audio channel between user 44 and user 46 on behalf of user 46. As user 46 defined a preference that requests for private audio channels be redirected to and handled by user 48 on behalf of user 46, user 48 may accept or cancel the request to establish a private channel (e.g., via GUI 410 and/or 412). In this way, PC process 10 may allow user 46 to pay attention to communications over the main audio channel and delegate responsibility for establishing and screening communications over the private audio channel to user 48. Further, if desired, user 48 may receive all communications over the private audio channel between user 44 and user 46 (e.g., in order to take minutes of the meeting).

Further, assume for illustrative purposes that the unified telephony meeting moderator (e.g., user 46) selects checkbox 510 via GUI 500 and enters a start time (via, e.g., text field 512) and an end time (via, e.g., text field 514). This may indicate that user 46 wishes to establish a private audio channel during a certain time frame (e.g., 10:45 am-11:15 am). As such, PC process 10 may schedule 116 the private audio channel (e.g., channel 308) between the unified telephony meeting moderator (e.g., user 46) and the first unified telephony meeting participant (e.g., user 44) to be established 102 during one or more time frames (e.g., 10:45 am-11:15 am) during the unified telephony meeting (e.g., unified telephony meeting 300) based upon, at least in part, the one or more private audio channel preferences (e.g., one or more of check boxes 502, 510, and 516) for providing the communication over the private audio channel during the unified telephony meeting. Here, PC process 10 may either receive requests to establish a private audio channel from one or more unified telephony meeting participants (e.g., user 44) between 10:45 am-11:15 am, or may automatically open a private audio channel (e.g., channel 308) with a designated user selected by user 46 (not shown) between 10:45 am-11:15 am. In this way, user 46 may ensure that a private audio channel will be open between user 46 and another unified telephony meeting participant (e.g., user 44) on which user 46 may depend, during a question/answer session of the unified telephony meeting (e.g., unified telephony meeting 300) which may occur between 10:45 am-11:15 am.

In an implementation, the unified telephony meeting moderator (e.g., user 46) may select checkbox 612 via GUI 600. This may indicate that user 46 wishes to have speech associated with a private audio channel converted to text and delivered to user 46's system (e.g., system 302). As such, PC process 10 may convert 118 a communication (e.g., a speech communication) over the private audio channel (e.g., channel 308) during the unified telephony meeting (e.g., unified telephony meeting 300) from speech to text based upon, at least in part, the one or more private audio channel preferences (e.g., one or more of check boxes 502, 510, and 516) for providing the communication over the private audio channel during the unified telephony meeting. Further, PC process 10 may provide 120 the text to the unified telephony meeting moderator (e.g., user 46). User 46 may receive the text via, e.g., GUI 326 which may be available to user 46 via the unified communications and collaboration application. The communication (e.g., speech communication) may be either a request to establish a private channel, which may include a communication in and of itself, or communication over an already established private channel. In this way, PC process 10 my allow user 46 to evaluate the substance of requests for private channels before granting them without being distracted from audio in the main audio channel.

It should be noted that while it has generally been discussed herein that a unified telephony meeting participant (e.g., user 44) requests a private audio channel with a unified telephony meeting moderator (e.g., 46), this is not intended to be a limitation of the present disclosure. In an implementation, a unified telephony meeting moderator (e.g., 46) may request a private audio channel with a unified telephony meeting participant (e.g., user 44). Further, in an implementation, a unified telephony meeting participant (e.g., user 44) may request a private audio channel with another unified telephony meeting participant (e.g., user 48). In this way, PC process 10 may allow a plurality of private audio channels to be established during a unified telephone meeting (e.g., unified telephony meeting 300) between multiple unified telephony meeting participants.

Further, it should be noted that PC process 10 may use a temporary, parallel IP stream for the private audio channel (e.g., channel 308), wherein the parallel IP stream is guided alongside the main audio channel (e.g., channel 310) stream. In this way, the main audio stream/main audio channel and the private audio stream/private audio channel may both be independent and individually configurable.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
allowing, via one or more computing devices, a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting;
establishing, via the one or more computing devices, the private audio channel between the unified telephony meeting moderator and a first unified telephony meeting participant based upon, at least in part, the one or more private audio channel preferences for establishing the private audio channel; and
providing, via the or more computing devices, the communication over the private audio channel during the unified telephony meeting, based upon, at least in part, the one or more private audio channel preferences for providing the communication over the private audio channel during the unified telephony meeting.

2. The method of claim 1, further comprising:
queuing at least one of the communication over the private audio channel and the communication over the main audio channel during the unified telephony meeting based upon, at least in part, the one or more private audio channel preferences for providing the communication over the private audio channel during the unified telephony meeting.

3. The method of claim 1, further comprising:
routing the communication over the private audio channel during the unified telephony meeting to a first audio output associated with the unified telephony meeting moderator based upon, at least in part, the one or more private audio channel preferences for providing the communication over the private audio channel during the unified telephony meeting; and
routing the communication over the main audio channel during the unified telephony meeting to a second audio output associated with the unified telephony meeting moderator based upon, at least in part, the one or more private audio channel preferences for providing the communication over the private audio channel during the unified telephony meeting.

4. The method of claim 3, further comprising:
adjusting a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting.

5. The method of claim 1, further comprising:
redirecting the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting.

6. The method of claim 1, further comprising:
scheduling the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting.

7. The method of claim 1, further comprising:
converting the communication over the private audio channel during the unified telephony meeting from speech to text based upon, at least in part, the one or more private audio channel preferences for providing the communication over the private audio channel during the unified telephony meeting; and
providing the text to the unified telephony meeting moderator.

8. A computer program product residing on a computer readable storage medium having a plurality of instructions stored thereon, which, when executed by a processor, cause the processor to perform operations comprising:
allowing a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting;
establishing the private audio channel between the unified telephony meeting moderator and a first unified telephony meeting participant based upon, at least in part, the one or more private audio channel preferences for establishing the private audio channel; and
providing the communication over the private audio channel during the unified telephony meeting, based upon, at least in part, the one or more private audio channel preferences for providing the communication over the private audio channel during the unified telephony meeting.

9. The computer program product of claim 8, further comprising:
queuing at least one of the communication over the private audio channel and the communication over the main audio channel during the unified telephony meeting based upon, at least in part, the one or more private audio channel preferences for providing the communication over the private audio channel during the unified telephony meeting.

10. The computer program product of claim 8, further comprising:
routing the communication over the private audio channel during the unified telephony meeting to a first audio output associated with the unified telephony meeting moderator based upon, at least in part, the one or more private audio channel preferences for providing the communication over the private audio channel during the unified telephony meeting; and
routing the communication over the main audio channel during the unified telephony meeting to a second audio output associated with the unified telephony meeting moderator based upon, at least in part, the one or more private audio channel preferences for providing the communication over the private audio channel during the unified telephony meeting.

11. The computer program product of claim 10, further comprising:
adjusting a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting.

12. The computer program product of claim 8, further comprising:
redirecting the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting.

13. The computer program product of claim 8, further comprising:
scheduling the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting.

14. The computer program product of claim 8, further comprising:
converting the communication over the private audio channel during the unified telephony meeting from speech to text based upon, at least in part, the one or more private audio channel preferences for providing the communication over the private audio channel during the unified telephony meeting; and
providing the text to the unified telephony meeting moderator.

15. A computing system comprising:
at least one processor;
at least one memory architecture coupled with the at least one processor;
a first software module executable by the at least one processor and the at least one memory architecture, wherein the first software module is configured to allow a unified telephony meeting moderator to define one or more private audio channel preferences for establishing a private audio channel and for providing a communication over the private audio channel during a unified telephony meeting, wherein the communication over the private audio channel is separate from a communication over a main audio channel of the unified telephony meeting;
a second software module executable by the at least one processor and the at least one memory architecture, wherein the second software module is configured to establish the private audio channel between the unified telephony meeting moderator and a first unified telephony meeting participant based upon, at least in part, the one or more private audio channel preferences for establishing the private audio channel; and
a third software module executable by the at least one processor and the at least one memory architecture, wherein the third software module is configured to provide the communication over the private audio channel during the unified telephony meeting, based upon, at least in part, the one or more private audio channel preferences for providing the communication over the private audio channel during the unified telephony meeting.

16. The computing system of claim 15, further comprising:
a fourth software module executable by the at least one processor and the at least one memory architecture, wherein the fourth software module is configured to queue at least one of the communication over the private audio channel and the communication over the main audio channel during the unified telephony meeting based upon, at least in part, the one or more private audio channel preferences for providing the communication over the private audio channel during the unified telephony meeting.

17. The computing system of claim 15, further comprising:
a fifth software module executable by the at least one processor and the at least one memory architecture, wherein the fifth software module is configured to route the communication over the private audio channel during the unified telephony meeting to a first audio output associated with the unified telephony meeting moderator based upon, at least in part, the one or more private audio channel preferences for providing the communication over the private audio channel during the unified telephony meeting; and
a sixth software module executable by the at least one processor and the at least one memory architecture, wherein the sixth software module is configured to route the communication over the main audio channel during the unified telephony meeting to a second audio output associated with the unified telephony meeting moderator based upon, at least in part, the one or more private audio channel preferences for providing the communication over the private audio channel during the unified telephony meeting.

18. The computing system of claim 17, further comprising:
a seventh software module executable by the at least one processor and the at least one memory architecture, wherein the seventh software module is configured to adjust a volume level of at least one of the communication over the private audio channel routed to the first audio output and the communication over the main audio channel routed to the second audio output based upon, at least in part, the one or more private audio channel preferences for providing the communication over the private audio channel during the unified telephony meeting.

19. The computing system of claim 15, further comprising:
an eighth software module executable by the at least one processor and the at least one memory architecture, wherein the eighth software module is configured to redirect the communication over the private audio channel during the unified telephony meeting to a second unified telephony meeting participant for handling the communication over the private audio channel based upon, at least in part, the one or more private audio channel preferences for providing the communication over the private audio channel during the unified telephony meeting.

20. The computing system of claim 15, further comprising:
a ninth software module executable by the at least one processor and the at least one memory architecture, wherein the ninth software module is configured to schedule the private audio channel between the unified telephony meeting moderator and the first unified telephony meeting participant to be established during one or more time frames during the unified telephony meeting based upon, at least in part, the one or more private audio channel preferences for providing the communication over the private audio channel during the unified telephony meeting.
